(19) United States
(12) Patent Application Publication
(10) Pub. No.: US 2005/0033960 A1
(43) Pub. Date: Feb. 10, 2005

(54) Message authentication

(76) Inventors: Jukka Vialen, Espoo (FI); Valtteri Niemi, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/476,988

(22) PCT Filed: Feb. 6, 2002
(86) PCT No.: PCT/EP02/01220

(30) Foreign Application Priority Data
Feb. 12, 2001 (GB) 0103416.4

(51) Int. Cl. H04L 9/00

(52) U.S. Cl. 713/170

(57) ABSTRACT

There is disclosed a technique of providing message authentication in a communication system comprising the steps of: transmitting a first message from a first device to a second device; transmitting a second message from the second device to the first device, the second message including a message authentication code determined using said first and second messages; transmitting a third message from the first device to the second device, the third messages including a message authentication code determined using the third message. The message authentication code of the third message may be additionally based on the second or the second and first messages.

### FIELD OF THE INVENTION

The present invention generally relates to a method for checking the integrity of messages in a communication system, particularly but not exclusively between a mobile station and a cellular network.

### BACKGROUND OF THE INVENTION

All telecommunication is subject to the problem of how to make sure that the information received has been sent by an authorized sender and not by somebody who is trying to masquerade as the sender. The problem is particularly evident in cellular telecommunication systems, where the air interface presents a potential platform for eavesdropping and replacing the contents of a transmission by using higher transmission levels, even from a distance. A basic solution to this problem is the authentication of the communicating parties. An authentication process aims to discover and check the identity of both the communicating parties, so that each party receives information about the identity of the other party and can rely on the identification to a sufficient degree. Authentication is typically performed in a specific procedure at the beginning of a connection. However, this does not adequately protect subsequent messages from unauthorized manipulation, insertion, and deletion. Thus, there is a need for the separate authentication of each transmitted message. The latter task can be carried out by appending a message authentication code (MAC-I) with a particular value to the message at the transmitting end and checking the MAC-I value at the receiving end.

A MAC-I is typically a relatively short string of bits based in some specified way on the message it protects and on a secret key known both by the sender and by the recipient of the message. The secret key is generated and agreed on typically in connection with the authentication procedure at the beginning of the connection. In some cases the algorithm that is used to calculate the MAC-I based on the secret key and on the message may also be secret.

The process of authentication of single messages is often called integrity protection. To protect the integrity of signaling, the transmitting party computes a MAC-I value based on the message to be sent and the secret key using the specified algorithm, and sends the message with the MAC-I value. The receiving party recomputes a MAC-I value based on the message and the same secret key according to the same specified algorithm, and compares the received MAC-I and the calculated MAC-I. If the two MAC-I values match, the recipient can trust that the message is intact and has been sent by the authorized party.

Known integrity protection schemes are not completely reliable. A third party can attempt to manipulate a message transmitted between a first and a second party. There are two main alternative methods for forging a MAC-I value for a modified or a new message: obtaining the secret key; or by trying directly without the secret key.

The secret key can be obtained by a third party in two ways:
i) by computing all possible keys until a key is found matching the data of observed message MAC-I pairs, or by otherwise breaking the algorithm for producing MAC-I values; or ii) by directly capturing a stored or transmitted secret key.

The original communicating parties can prevent a third party from obtaining the secret key by using an algorithm which is cryptographically strong and which uses a secret key which is long enough to prevent the exhaustive search of all keys, and by using other security means for the transmission and storage of secret keys.

A third party may try to disrupt the sending of messages between the two parties without a secret key by guessing the correct MAC-I value, or by replaying some earlier message transmitted between the two parties for which message the correct MAC-I is known from the original transmission.

Guessing of the correct MAC-I value can be made difficult by using long MAC-I values. The MAC-I value should be long enough to reduce the probability of correct guessing to a sufficiently low level compared to the benefit gained by one successful forgery. For example, using a 32 bit MAC-I value reduces the probability of a correct guess to 1/4294967296, which is small enough for most applications.

Obtaining a correct MAC-I value using the replay attack, i.e. by re-playing an earlier message, can be prevented by introducing a varying parameter to the calculation of the MAC-I values. For example, a time stamp value, a sequence number, or a random number can be used as further input to the MAC-I algorithm, in addition to the secret integrity key and the message. In the following, the prior art methods are described in more detail.

When using sequence numbers, each party has to keep track of which sequence numbers have already been used and are not acceptable any more. The easiest way to implement this is to store the highest sequence number used in MAC-I calculations so far. This approach has the drawback that between connections each party must maintain state information which is at least to some level synchronized. That is, they need to store the highest sequence number used so far. This requires the use of a large database in the network.

A further approach is to include a random number in each message, which the other side must use in MAC-I calculation the next time a message is sent for which MAC-I authentication is required. This approach has the same drawback as the previous one, i.e. between connections each party must maintain state information, which requires the use of a large database in the network.

By way of example, FIG. 1 illustrates the computation of a message authentication code in the UTRAN (UMTS Terrestrial Radio Access Network), which is a wideband multiple access radio network currently being specified in the 3GPP (Third Generation Partnership Project). The length of the MAC-I used in UTRAN is 32 bits.

Block 100 represents the UMTS integrity algorithm for generating the message authentication code. The UMTS integrity algorithm used in block 100 is a one-way cryptographic function for calculating the 32 bit Message Authentication Code (MAC-I) based on the five input parameters shown in FIG. 1. A one-way function makes it impossible to derive the unknown input parameters from a MAC-I, even if all but one input parameter are known.

The input parameters for calculating the MAC-I 20 are: the actual signaling message 10 (after encoding) to be sent, a secret integrity key 12, a number COUNT-I value 14 for the message to be integrity protected, a value indicating the direction of transmission 16, (i.e. whether the message is sent in uplink or downlink direction), and a random number 18 (FRESH) generated by the network. The COUNT-I value consists of a hyper frame number HFN and the message sequence number SN. The computing block 100 calculates the message authentication code by applying the afore-mentioned parameters to the integrity algorithm, which is called the f9 algorithm in 3GPP Release'99 specifications.

FIG. 2 illustrates a typical message to be sent over a radio interface. The message is a layer N protocol data unit (PDU) 200, which is transferred as a payload 30 in a layer N-1 PDU 201. In the present example, layer N represents the Radio Resource Control (RRC) protocol in the radio interface and layer N-1 represents the Radio Link Control (RLC) layer. The layer N-1 PDU normally has a fixed size, which depends on the physical layer (the lowest layer, not visible in FIG. 2) the channel type used and on other parameters, e.g. modulation, channel coding, interleaving. If layer N PDUs are not exactly the size of the payload 30 offered by layer N-1 as is normally the case, layer N-1 can utilize functions like segmentation, concatenation, and padding to make layer N-1 PDUs a fixed size.

In the example discussed herein, a layer N PDU consisting of the actual signaling data 22 and the Integrity Check Info is discussed. The Integrity Check Info consists of the 32 bit MAC-I 26 and the message sequence number SN 24, which is needed at the peer end for the recalculation of MAC-I. The total length of the message 200 is then a combination of the signaling bits and the Integrity Check Info bits.

At the receiving end the message is received including the signaling data part and the Integrity Check Info (which comprises the message sequence number SN and the 32-bit MAC-I). The signaling data together with the Integrity Check Info (ie the secret integrity the COUNT-I value, the direction of transmission, and the random number (FRESH)), are processed in a computing block, for example a function like the UTRAN f9 function, with a fixed function. A thus generated received computed message authentication code XMAC-I is then compared with the message authentication code MAC-I received in the transmitted message. If the two codes match (ie XMAC-I matches MAC-I), the recipient can trust that the message is intact, and the recipient then accepts the message. Otherwise, the message is discarded.

The frame dependent COUNT-I number is actually the sum of a locally generated and incremented frame number HFN (Hyper Frame Number), which is added to the message sequence number, for example RRC_SN, and included in the message. The HFN is incremented each time SN reaches its maximum value (SN is normally very short, e.g. 4 bits).

As mentioned hereinabove the transmitted.block (layer N-1 PDU) normally has a fixed length. However, it may be that the signaling data bits together with the Integrity Check Info require more space than that provided in one layer N-1 PDU payload. One known way to deal with this problem is to segment the signaling message.

In segmentation a signaling message, which is too long to fit in a single layer N-1 block, is passed on to a lower layer, where it is split up into two blocks (two layer N-1 PDUs), each with an appropriate layer N-1 header. Two blocks is just an example here, naturally a larger message may require even more than two blocks. If the second layer N-1 PDU is not totally filled with the layer N data, padding bits are inserted. At the receiving end before transferring to a higher layer, the two layer N-1 payloads are reassembled into one layer N PDU. To a person skilled in the art, it is immediately obvious that the use of padding bits is a potential waste of resources.

TDMA systems, for example, have a limited radio block size, whereby a message including the full message authentication code does not necessarily fit into one radio block. This leads to the difficulty that the message has either to be sent without the MAC-I or in one or more additional segments.

In addition, there are certain time critical messages, for example, handover messages, which must be sent in one radio block only. Generally, segmentation is not desirable, because it wastes radio resources and slows down the signaling procedure unnecessarily.

One way to solve the above problem is to make the length of the message authentication code shorter than 32 bits. It has been proposed that such a message should include a field that defines the length of the message authentication code, a two-bit identifier, for example. This identifier allows certain discrete values: 8, 16, 24 and 32. This solution still has some problems. First, the identifier always takes two extra bits from the length of the message. Second, the discrete values are not flexible, and in some cases this can lead to the same problem as above, i.e. segmentation is needed for certain messages.

A particularly advantageous technique for addressing the above stated problems is disclosed in Finnish patent application number FI20002453. This discloses a technique that allows the transmission of a message in a single lower layer data block even when the length of the message including the integrity check info exceeds the length of the lower layer data block.

In all current known solutions, each message is authenticated separately. Each message contains a sequence number of the protocol it belongs to. Hence a binding between different steps in the existing solutions is achieved through the sequence number. The drawback to existing solutions is that at each step a 32-bit MAC is transmitted which takes a significant part of the signaling bandwidth.

It is therefore an object to the present invention to provide an improved technique for taking the integrity of messages.

### SUMMARY OF THE INVENTION

In accordance with the present invention there is provided a method of providing message authentication in a communication system comprising the steps of: transmitting a first message from a first device to a second device; transmitting a second message from the second device to the first device, the second message including a message authentication code determined using said first and second messages; transmitting a third message from the first device to the second device, the third messages including a message authentication code determined using the third message.

In order to minimize the risk of ‘replay attacks’, the sequence numbers should preferably be maintained in the protocol. This is particularly important if the messages are short or otherwise small in number. The method may further comprise the step of storing the first message in the first device.

The method may further comprise the steps of: responsive to receipt of the second message, determining an expected message authentication code using said first and second messages; and comparing the expected message authentication code to the received message authentication code. The method may further comprise the step of discarding the second message if the expected message authentication code does not match the received message authentication code.

The method may further comprise the steps of: responsive to receipt of the third message, determining an expected message authentication code using said third message; and comparing the expected message authentication code to the received message authentication code. The method may further comprise the step of discarding the third message if the expected message authentication code does not match the received message authentication code.

The third message may include a message authentication code determined using the third message and the second message.

The method may further comprise the step of storing the second message in the second device.

The method may further comprise the steps of: responsive to receipt of the third message, determining an expected message authentication code using said third message and said second message; and comparing the expected message authentication code to the received message authentication code. The method according to claim 9 may further comprise the step of discarding the third message if the expected message authentication code does not match the received message authentication code.

The third message may include a message authentication code determined using the third message, the second message, and the first message.

The method may further comprise the step of storing said first message in the second device.

The method may further comprise the steps of: responsive to receipt of the third message, determining an expected message authentication code using said third message, said second message, and said first message; and comparing the expected message authentication code to the received message authentication code. The method may further comprise the step of discarding the third message if the expected message authentication code does not match the received message authentication code.

The invention may thus advantageously reduce the bandwidth used for authentication. In a multi-step protocol, the invention provides for the messages exchanged at different steps to be grouped together for message authentication code computations. A message is saved by the sending party for subsequent verification at a later step.

The number of required message authentication code computations and transmissions may be reduced to two independently of the number of steps in the authentication procedure.

In three step signaling procedures, there is thus no need for a message authentication code to be computed in the first step.

The invention is further advantageously applicable to procedures containing more than three messages. All communications that occur between two parties in various steps may be authenticated by the communicating parties in the last two steps of the protocol.

The first and second devices are preferably elements of a mobile communication system.

### BRIEF DESCRIPTION OF THE DRAWINGS

The invention will be described more closely with reference to the accompanying drawings, in which

FIG. 1 depicts the computation of a message authentication code;

FIG. 2 shows the contents of a message;

FIG. 3 illustrates a first embodiment of the present invention;

FIG. 4 illustrates a second embodiment of the present invention;

FIG. 5 depicts the creation of a message according to a preferred implementation;

FIG. 6 is a flow chart showing the creation of a message in the GERAN system, and

FIG. 7 is a flow chart of actions at the receiving end.

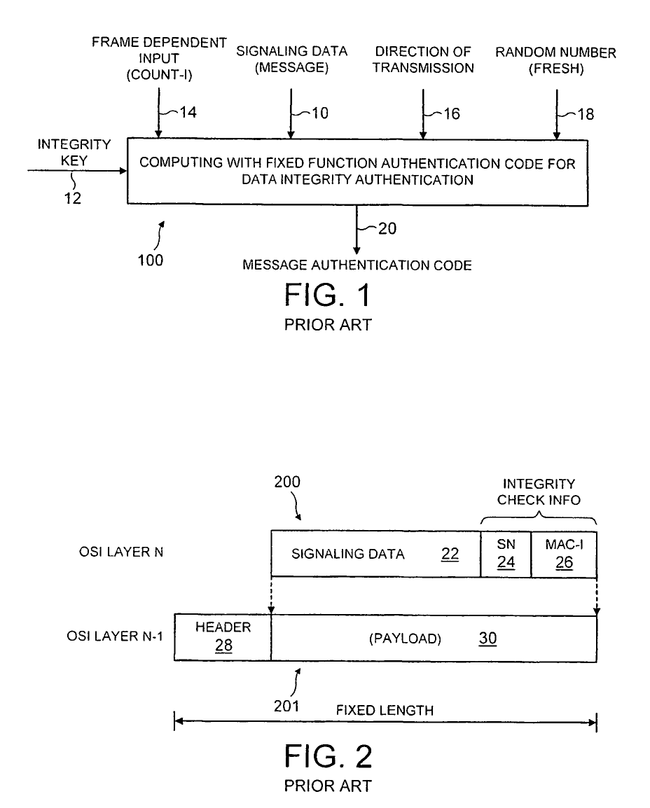

### DESCRIPTION OF PREFERRED EMBODIMENTS

The invention is described herein by way of reference to particular non-limiting examples, and with particular reference to a GERAN system. The GERAN is specified by the Third Generation Partnership Project (3GPP). GERAN is an evolution of the GSM-system (Global System for Mobile Communication), the TDMA/136-system (Time Division Multiple Access System), and the EDGE-system. GERAN has no integrity protection of its own. Implementation of the same integrity algorithms used in UTRAN is suggested for a radio system using the GPRS/EDGE-radio connection network GERAN. This leads to certain significant problems, especially the problem of message segmentation.

The present invention can be advantageously used for implementing an integrity algorithm in the GERAN system, and the present invention is described herein with reference to example implementations in such a system. However, the invention is not limited in its application to such a system.

Radio interface protocols are needed to set up, reconfigure, and release Radio Bearer services. The protocol layers above the physical layer are called the data link layer (layer 2) and the network layer (layer 3). The control plane layer 2 contains two sub-layers: Medium Access Control (MAC) protocol and Radio Link Control (RLC) protocol. Layer 3 consists of one protocol, called Radio Recourse Control (RRC), which belongs to the control plane. The channels offered by the physical layer to the MAC layer are called logical channels. It shall be appreciated that the term ‘logical channel’ can be used for other purposes in other systems. For example, in the UTRAN the term logical channel referes to a channel offered by the MAC layer to higher layers.

All higher layer signaling (mobility management, call control, session management, etc.) is encapsulated into RRC messages for transmission over the radio interface.

The following provides a description of integrity protection for a message to be sent over a radio link.

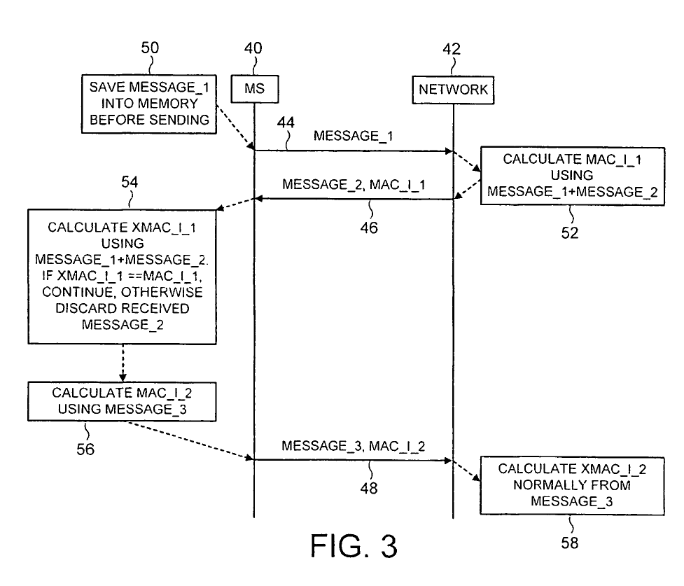

Referring to FIG. 3, a first embodiment of the present invention is described. For the purpose of this illustrative example, it is assumed that messages are being exchanged between the mobile station 40 and a network 42. It is assumed that the mobile station 40 initiates the exchanged messages.

The mobile station 40 constructs a message for transmission in the normal way in accordance with standard procedures. Prior to transmitting the message, as indicated by step 50, the mobile station 40 stores the initial message, labeled message_1, in its memory. As indicated by arrow 44, message_1 is then transmitted from the mobile station 40 to network 42. In accordance with the present invention, the first message is sent without a message authentication code. The network 42 receives the first message from the mobile station, and prepares a second message, message_2, for transmission back to the mobile station 40. In addition, in a step 52 the network 42 calculates a first message authentication code, MAC_I_1, using both the first message as received by the mobile station and the second message which it is to transmit to the mobile station. Thus the message authentication code to be transmitted with the second message is based on the combination of both the first and second messages. As indicated by arrow 46, the network 42 then transmits a second message, message_2, with the message authentication code MAC_I_1.

Using the received second message, message_2, and the stored first message, message_1, the mobile station 40 in a step 54 calculates the expected message authentication code XMAC_I_1. If XMAC_I_1 is identical to MAC_I_1, then the mobile station 40 continues with message transmission. Otherwise the received message message_2 is discarded.

In this embodiment of the invention, the mobile station 40 prepares to transmit a third message message_3 to the network 42. In the step 56 the mobile station 40 prepares a second message authentication code MAC_I_2 using the content of the third message message_3. As represented by arrow 58, the third message message_3 is transmitted to the network 42 together with the second message authentication code MAC_I_2.

The network 42 then calculates the expected message authentication code XMAC_I_2 using the third message message_3 in step 58, and in the normal way compares this to the transmitted authentication code MAC_I_2.

Whilst in FIG. 3 the three messages are identified as message_1, message_2 and message_3, in actual signaling procedures they may be named, for example, XXX_request, XXX_command, XXX_complete (or “confirm”).

Thus in accordance with the first embodiment of the invention, the message authentication code is left out of the first message. The message authentication code for the second message is calculated over the first and second messages, although the first message is not returned to the sender. The third message is integrity protected “normally”, with a message authentication code calculated over the third message itself. This technique ensures that the procedure cannot be used illegally by an intruder, even if the first message is not integrity protected.

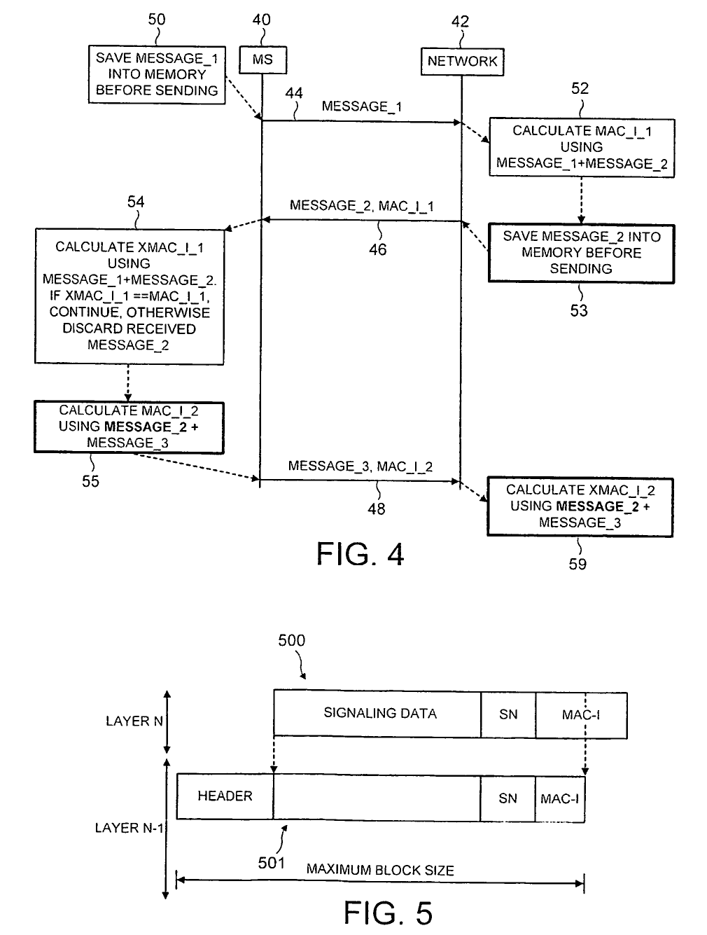

Referring to FIG. 4, the second embodiment of the present invention is now described. Where appropriate, the same reference numerals as used in FIG. 3 are used to refer to identical steps or procedures. The embodiment of the invention described with reference to FIG. 4 is suitable for signaling procedures normally having either two or three messages.

As in the embodiment described hereinabove with reference to FIG. 3, the mobile station 40 prepares a first message message_1 for transmission to the network 42, and prior to transmitting it, as represented by arrow 44, stores it in a memory as represented by step 50. In step 52, the network 42 calculates a first message authentication code MAC_I_1 using both the first message and the second message. In an additional step 53, the network 42 saves the second message message_2 into its memory before transmission. As in the embodiment of FIG. 3, the network 42 transmits the second message message_2 together with the first message authentication code MAC_I_1 as indicated by arrow 46 to the mobile station 40.

In step 54, as in the embodiment of FIG. 3, the mobile station 40 calculates the expected message authentication code XMAC_I_1 using both the received second message and the stored first message. If the expected message authentication code XMAC_I_1 is identical to the received message authentication code MAC_I_1, then the procedure is continued with.

In this embodiment of the present invention, the mobile station 40 then calculates in step 55 a second message authentication code MAC_I_2 using both the third message to be sent, message_3, and the received second message, message_2. The mobile station 40 then transmits, as indicated by arrow 48, the third message, message_3, together with the message authentication code MAC_I_2.

The network 42 then calculates the expected second message authentication code XMAC_I_2 using both the stored second message message_2 and the received third message message_3 in step 59.

Thus, in common with the first embodiment described hereinabove with reference to FIG. 3, the second embodiment as described with reference to FIG. 4 similarly does not include any message authentication code in the first transmitted message. The difference of the second embodiment compared to the first embodiment is that the third message contains a message authentication code calculated over both the second and third messages, whereas in the first embodiment the message authentication code is calculated over only the third message.

The technique of FIG. 4 may be more advantageous in situations where the third message is added only for this purpose, ie it does not contain any actual information but is merely an acknowledgement message and is thus very short. From a security viewpoint, the calculation of the integrity check sum over a longer message is beneficial.

The addition of a third message may be more preferable than segmentation of the first message, because the segmentation solution necessitates additional acknowledgement (on data link layer level).

In a third embodiment of the present invention, the message authentication code transmitted with the third message is calculated over all three messages, ie message_1, message_2 and message_3. The advantage of this embodiment is that each check sum protects the maximum amount of the data communicated in the procedure. Thus, this variation excludes the possibility of an attack where a “man in the middle” replaces the first message with another one and modifies the message authentication code in the second message accordingly. Such an attack could only be successful if the attacker is able to modify the check sum correctly. There are two possible ways to do this: 1) the replay of an earlier message authentication code; or 2) pure guessing.

The first way is only possible if the counter number repeats, which means the same integrity key has been in use for too long. The possibility of the second way being successful is a very low probability. However, if the message authentication code of the second message is not a full 32-bits long, the probability of the guessing attack becomes higher.

If the “man in the middle” is to have any chance of making a successful attack when the third embodiment of the invention is in use, then it is necessary for either 1) or 2) to be succeeded twice, which is much more difficult.

The present invention can particularly advantageously be used in combination with the technique described in Finnish patent application number FI120002453. Such a technique is described hereinbelow. It should be noted that the techniques described hereinbelow may only be utilized in steps where a message authentication code is being generated, and hence would not be used in accordance with the invention in relation to the generation and transmission of the first message. It should also be noted that other techniques may also be used.

FIG. 5 illustrates a situation where a signaling message 500 is to be sent in a secure manner over a lower layer radio link in one fixed length radio block, which can be a TDMA block, for example, without segmentation. The maximum block size allowed by the lower layer data block 501 is indicated by dotted lines in the figure. The signaling message without the Integrity Check Info (ICI) is in the illustrated situation shorter than the said maximum block size. This leads to a situation where the data to be sent either has to be segmented or sent without the message authentication code. Neither of these alternatives is acceptable.

In order for the data to be sent in a sufficiently secure manner over a radio link, the computed message authentication code should be appended to it. However, it must be shortened in a predefined way (described in detail below). This truncated message authentication code diminishes the reliability of the integrity protection to some degree but still provides sufficient protection for the message. It should be noted, that the sequential number SN needed to form the COUNT-I parameter cannot be truncated. The message authentication code may be computed in the usual way in the device concerned and the MAC-I added with the message sequence number to the encoded message to form the actual PDU. Then the length of the message (without the Integrity Check Info) and/or the length of the PDU can be examined as follows.
i) If the length of the message is longer than the length of the lower layer data block, the PDU is segmented into two or more data blocks as in prior art.
ii) If the length of the PDU is shorter than the length of the lower layer data block, the PDU is placed into said lower layer data block and the rest of the block is filled with padding bits (normally by the lower layer itself).
iii) If the length of the PDU is longer than the length of the lower layer data block but the extra bits are less than the size of the MAC-I, then the computed message authentication code is truncated so that the truncated PDU fits into one layer N-1 data block. However, truncation of the message authentication code diminishes the security of the message exchange. Therefore, the number of bits the MAC-I is allowed to be truncated by is limited to a certain maximum value, i.e. the truncated message authentication code has a certain minimum value. Thereafter, the truncated PDU is sent via a radio interface to the receiving end. At the receiving end the integrity is examined of the PDU received. First, the part including the signaling bits and the part including the Integrity Check Info are separated. Then a message authentication code is recomputed based on exactly the same algorithm and using the same parameters as were used at the transmitting end. The message authentication code of the received message is then compared with the recomputed authentication code.

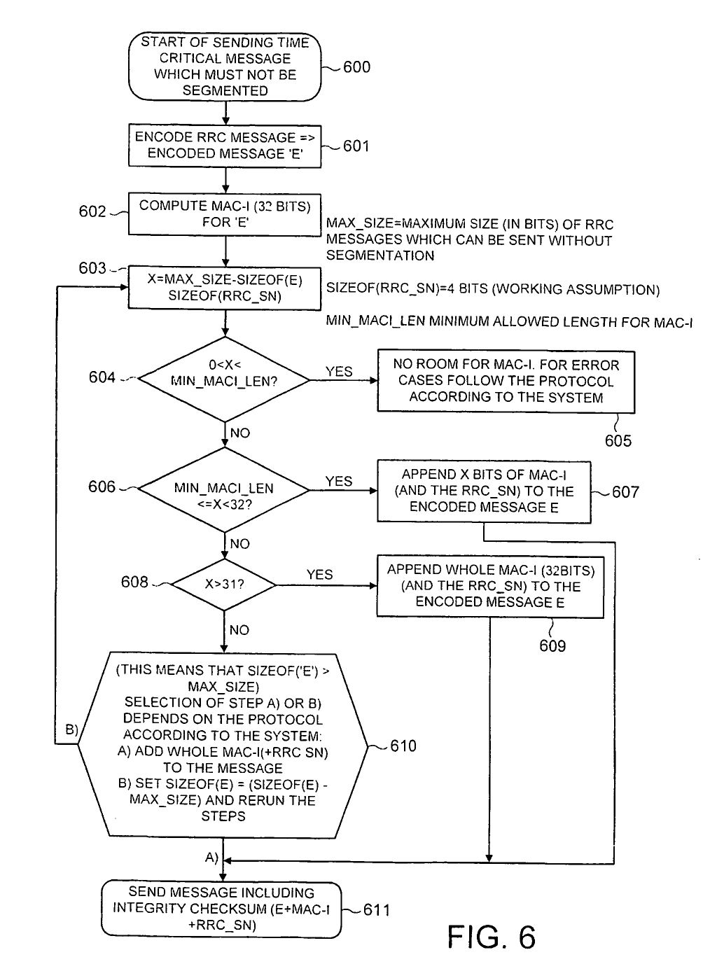

FIG. 6 shows as a flowchart a more detailed example of one implementation of the method according to the invention from the point of view of the transmitting end.

At stage 600 a time critical RRC message is to be sent through a radio interface, for example from the network to a mobile.

Most signaling messages sent between a mobile station MS and the network, for example, must be integrity protected. Examples of such messages are RRC, MM, CC, GMM, and SM messages. Integrity protection is applied at the RRC layer, both in the mobile station and in the network.

Integrity protection is usually performed for all RRC (Radio Recourse Control) messages, with some exceptions. These exceptions can be:
1. messages that are assigned to more than one recipient, —messages that have been sent before integrity keys were created for the connection,
2. frequently repeated messages, including information which does not need integrity protection.

The message is encoded according to the specified message transfer syntax at stage 601. The encoded message (bit string) is called here E.

A 32-bit message authentication code MAC-I, which is to be added to the encoded message, is calculated at stage 602.

The message authentication code not only depend on the encoded message but also on several other parameters. The following input parameters are needed for calculation of the integrity algorithm: the encoded message, the 4-bit sequence number SN, the 28-bit hyper-frame number HFN, the 32-bit random number FRESH, the 1-bit direction identifier DIR, and the most important parameter—the128-bit integrity key IK. The short sequence number SN and the long sequence number HFN together compose the serial integrity sequence number COUNT-I.

When the message authentication code is computed using the UMTS integrity algorithm and the above parameters, it is guaranteed that no one other than the actual sender can add the correct MAC-I code to the signaling message. COUNT-I, for example, prevents the same message from being sent repeatedly. However, if the same signaling message for some reason or other is to be sent repeatedly, the MAC-I code differs from the MAC-I code that was in the previously sent signaling message. The aim of that is to protect the message as strongly as possible against eavesdroppers and other fraudulent users.

Due to the fact that a TDMA radio block has a fixed length, the length of the message has to be checked to avoid segmentation of the message. The RRC layer makes a decision as to whether the segmentation of the message concerned is to be allowed or not.

At stage 603 the total length of the signaling message to be sent without the message authentication code is calculated using the following formula:
X=max_size−sizeof(E)−sizeof(RRC_SN)

In the above formula max_size is the maximum size (in bits) of a RRC message that can be sent in one radio block (i.e. there is no need for segmentation). Sizeof(E) is the size (in bits) of the encoded message and sizeof(RRC_SN) is the size of the RRC sequence number, a 4-bit working assumption. X defines the length (in bits) of the rest of the fixed length message, which is still left after the minimum number of bits are reserved for the message authentication code, the untruncated MAC-I size may be different.

Next, at stage 604, a comparison is made to ascertain whether the calculated X is between values 0 and min_MACI_len, where the latter value is the minimum allowed length for the message authentication code. This minimum length is a predefined value, which can be either the same for all messages or even a message type specific value. It is clear that the smaller the value, the weaker the protection. So it is obvious that a minimum length must be determined so that the message can be sent with adequate security.

If the answer after said comparison is YES, this means that the message authentication code does not fit with the signaling message to be sent in one radio block. In other words, the space left in one radio block is too short even for a shortened message authentication code after the signaling message is put into the block. If this is the case, the system protocol defines 605 as the next action to be carried out.

If the answer after comparison is NO, the next step is to compare whether X is between values min_MACI_len and 32, stage 606.

If X is between those values, i.e. if the answer after the comparison in stage 604 is YES, then X bits of the message authentication code with the RRC_SN are added to the encoded message, stage 607. The sequence number RRC_SN is needed for integrity protection, that is, for calculation of the message authentication code at the receiving end. Note that the MAC-I size is also 32 bits in the UTRAN system. In some other systems, the ‘normal’ MAC-I size may be something different.

The length of the message authentication code is shortened in a predefined way. Thus, the size of the message authentication code transmitted over the radio path depends dynamically on the size of each encoded message, not on the type of the message.

The decisions are made at the RRC layer as to the minimum message authentication code size and as to when the size of the said code may be shortened. In some cases the RRC layer can make the decision that the message authentication code is not to be shortened even though this would have been possible. Such cases might occur when strong protection is demanded for a message.

The next step 611 is to send the message including the integrity protection info (E+MAC-I+RRC_SN) to the lower layers for transmission over the radio interface to the mobile station.

If the answer in the above comparison 604 is NO, a final comparison is made as to whether the value of X is greater than 31, stage 608. If the answer is YES, this means that neither shortening nor segmentation is needed. Now the whole message authentication code and the RRC_SN are appended to the encoded message E, stage 609. The next step is stage 611.

If the answer to the comparison at stage 608 is NO, i.e. if X is smaller than 0, which means that the size of the encoded message sizeof(E) is greater than the maximum size of the RRC message max_size, then two different alternatives A and B, are possible at stage 610:
1. add the entire MAC-I (+RRC_SN) to the message;
2. set sizeof(E)=(sizeof(E)−max_size) and rerun the previous steps.

Which of the two above alternatives is selected depends on the protocol according to the system.

Alternative A means that the whole message authentication code with the sequence number RRC_SN is added to the block, since the message has to be segmented anyway. Thus with this alternative, it is not important whether adding Integrity Protection Info causes additional segmentation or not.

In alternative B, the attempt is made to avoid the additional segmentation caused by the addition of Integrity Check Info. Thus the sizeof(E) is set one full data block shorter than what was given in stage 601, and the truncation algorithm for the MAC-I is rerun starting from step 603.

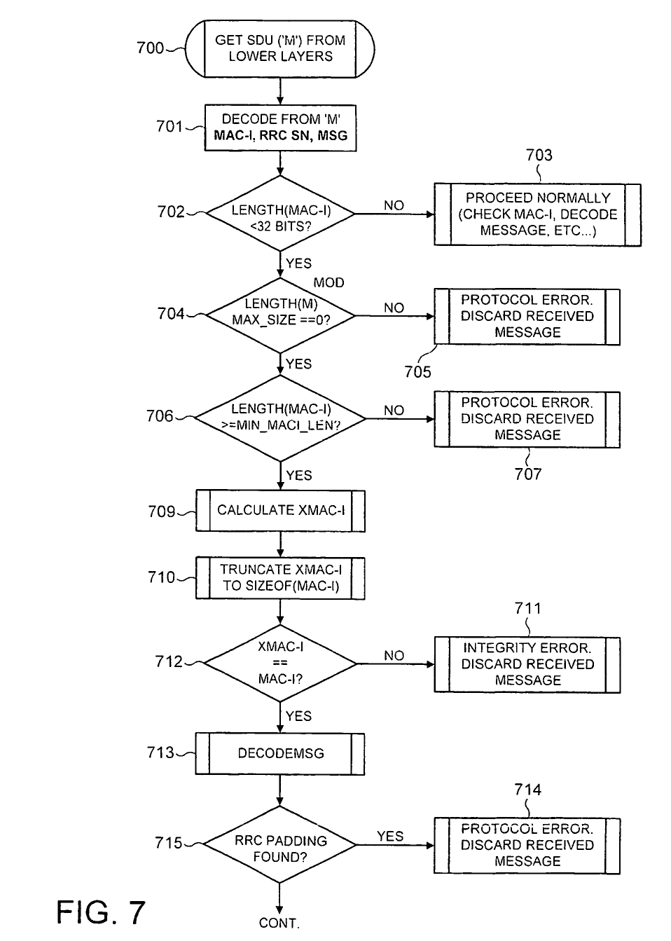

FIG. 7 shows as a flowchart an example of one implementation of the method according to the invention from the point of view of the receiving end.

At stage 700 the receiving end gets a Service Data Unit (SDU) comprising the signaling data M from the lower layers. It is assumed here that this message is the same as in the previous example in FIG. 6. The next step is that the part including signaling data bits and the part including the Integrity Check Info MAC-I (the message authentication code with the sequence number the RRC_SN) are separated and a message authentication code with RRC sequence number RRC_SN is decoded in stage 701. The actual message (signaling data) can still be stored as an encoded bit string at this point.

In prior art systems the message received is discarded immediately if the received and the recomputed message authentication codes do not match. But according to the described embodiment of the invention, the receiving end first examines the length of the message authentication code and, depending on the result, it then decides, if and how the message is to be processed further.

For example, if the receiving end finds that the message authentication code received is shorter than it should be, it may assume that the code has been truncated. Instead of n bits the truncated code comprises m bits. If the truncation exceeds the predetermined maximum amount known by the receiving end, the message is discarded. If truncation does not exceed the predetermined maximum amount as known by the receiving end, the bits of the truncated message authentication code are compared bit-by-bit to the bits of the recomputed authentication code of full length. When the m bits of the truncated message authentication code match the corresponding bits of the recomputed message authentication code, the integrity check of the message received is passed.

The length of the message authentication code of the message received is examined at stages 702 and 706. In addition, the length of the entire message (including the signaling data and the integrity check info) received is also examined at stage 704.

At stage 702 a check is made as to whether the length of the MAC-I is ‘normal’, in this example 32 bits. If YES (the answer to stage 702 is NO), the flow proceeds to stage 703, where the message is processed in the normal way. The message authentication code is checked, the message is decoded, etc. using the same algorithm and parameters as were used at the transmitting end.

Provided that stage 702 yields the YES alternative, meaning that the MAC-I has been truncated, a check is made as to whether the length of the message is a multiple of the max_size (sizeof(M) mod max_size—0), justifying the MAC-I truncation. A NO alternative yields a protocol error, for which reason the message received is discarded 705.

A YES answer after stage 704 leads to stage 706, when a comparison is made as to whether the length of the message authentication code is greater than or equal to the minimum allowed MAC-I length (min_MACI_len). A NO alternative yields a protocol error, for which reason the received message is discarded 707. If the length is greater than or equal to the minimum value, the transmitting end may have shortened the MAC-I code in the correct way. With the integrity key and all the other needed parameters, the expected message authentication code XMAC-I is calculated 708, using the same algorithm as for the transmitting end. The calculated XMAC-I has to be truncated in order to compare its size with the size of the transmitted MAC-I, stage 709. If the truncated XMAC-I does not correspond to the transmitted truncated MAC-I 710, an integrity error is found and the received message is discarded 711. If the result of the comparison is positive, the message is decoded 712. The final check 713 is made after decoding the actual signaling data 712. The final check is to find out whether there are some padding bits in the received message. Since the MAC-I has been truncated due to message size, no padding bits are allowed (since the padding bits should have been used for the MAC-I). The Integrity check is OK whenever no RRC padding bits are found 713, i.e. it is then ensured that the message has been sent from the authorized party 715. Otherwise, a protocol error is found and the message is discarded, stage 714.

The above defined preferred technique for generation of the message authentication code may be used in the embodiments of the present invention at those steps where a message authentication code is generated.

An implementation and embodiment of the present invention has been explained above with some examples. However, it is understood that the invention is not restricted to the details of the above embodiment and that numerous changes and modifications can be made by those skilled in the art without departing from the characteristic features of the invention. The embodiment described is to be considered illustrative but not restrictive. Therefore, the invention should be limited only by the attached claims. Thus, alternative implementations defined by the claims, as well as equivalent implementations, are included in the scope of the invention.

For example, instead of at the RRC layer the decision concerning the MAC-I size can be made at some other layer, e.g. the RLC layer. In that case, the RLC must know whether segmentation of the message(s) in the transmission buffer is to be allowed or not.

The protocol layers from top to bottom may be, for example, RRC, LLC (Logical Link Control), LAPDm (Link Access Protocol on the Dm channel), PDCP (Packet Data Convergence Protocol), RLC, MAC (Medium Access Control Protocol), and PHY (Physical Layer)

In addition, the minimum value, which is set at min_MACI_len might also depend on the signaling message used. The grouping of signaling messages into different min_MACI_len categories can be carried out either simply according to the message type. Grouping can be based on other factors as well, such as on whether the message is so that for critical signaling messages the value is greater than for non-critical signaling messages. For some non-critical messages the min_MACI_len could be set as low as 8 bits, for example.

Utilised in combination with the techniques described with reference to FIGS. 5 to 7 the present invention may allow, in certain situations, a longer MAC-I, thereby further improving integrity.

The present invention is independent of the length of the message authentication code. Such code may be longer or shorter than 32 bits. The length may also differ between messages in one procedure.

It should also be noted that although this application is made only from the signaling standpoint, integrity protection can also be applied in some systems to the user plane data. The same principles and methods described in this application are applicable also for user plane data packets, although the actual protocol layers performing the integrity protection, and the message authentication code truncation would then be different.

1. A method of providing message authentication in a communication system comprising the steps of:
transmitting a first message from a first device to a second device;
transmitting a second message from the second device to the first device, the second message including a message authentication code determined using said first and second messages;
transmitting a third message from the first device to the second device, the third message including a message authentication code determined using the third message.

2. A method according to claim 1, further comprising the step of storing the first message in the first device.

3. A method according to claim 1 further comprising the steps of:
responsive to receipt of the second message, determining an expected message authentication code using said first and second messages; and
comparing the expected message authentication code to the received message authentication code.

4. A method according to claim 3 further comprising the step of discarding the second message if the expected message authentication code does not match the received message authentication code.

5. A method according to claim 1 further comprising the steps of:
responsive to receipt of the third message, determining an expected message authentication code using said third message; and
comparing the expected message authentication code to the received message authentication code.

6. A method according to claim 5 further comprising the step of discarding the third message if the expected message authentication code does not match the received message authentication code.

7. A method according to claim 1, wherein the third message includes a message authentication code determined using the third message and the second message.

8. A method according to claim 7, further comprising the step of storing the second message in the second drive.

9. A method according to claim 7, further comprising the steps of:
responsive to receipt of the third message, determining an expected message authentication code using said third message and said second message; and
comparing the expected message authentication code to the received message authentication code.

10. A method according to claim 9 further comprising the step of discarding the third message if the expected message authentication code does not match the received message authentication code.

11. A method according to claim 1, wherein the third message includes a message authentication determined using the third message, the second message, and the first message.

12. A method according to claim 11, further comprising the step of storing said first message in the second device.

13. A method according to claim 11, further comprising the steps of:
responsive to receipt of the third message, determining an expected message authentication code using said third message, said second message, and said first message; and
comparing the expected message authentication code to the received message authentication code.

14. A method according to claim 13 further comprising the step of discarding the third message if the expected message authentication code does not match the received message authentication code.

15. A method according to claim 1 wherein the first and second devices are elements of a mobile communication system.

16. A method of providing message authentication in a communication system comprising transmitting a plurality of messages between a first device and a second device, wherein a message includes a message authentication code determined using at least said message and another message includes a further message authentication code determined using at least said other message, whereby the number of required message authentication code computations and transmissions may be reduced to two independently of the number of steps of the authentication procedure.

17. A communication system for providing message authentication between two communicating devices, each communicating device having respective transmitting and receiving means, and each communicating device having means for generating a message authentication code, comprising:
in the first device, transmitting a first message from the second device;
in the second device, transmitting a second message to the first device, the second message including a message authentication code determined using said first and second messages;
in the first device transmitting a third message to the second device, the third messages including a message authentication code determined using the third message.

18. A communication system according to claim 17, further including, in the first device:
responsive to receipt of the second message, determining an expected message authentication code using said first and second messages; and
comparing the expected message authentication code to the received message authentication code.

19. A communication system according to claim 17 wherein the second message is discarded if the expected message authentication code does not match the received message authentication code.

20. A communication system according to claim 17 further comprising, in the second device:
responsive to receipt of the third message, determining an expected message authentication code using said third message; and
comparing the expected message authentication code to the received message authentication code.

21. A communication system according to claim 20 wherein the third message is discarded if the expected message authentication code does not match the received message authentication code.

22. A communication system according to claim 17, wherein the first device generates the third message including a message authentication code determined using the third message and the second message.

23. A communications system according to claim 22, wherein responsive to receipt of the third message, the second device determines an expected message authentication code using said third message and said second message; and compares the expected message authentication code to the received message authentication code.

24. A communications system according to claim 23 wherein the third message if the expected message authentication code does not match the received message authentication code.

25. A communications system according to claim 17 wherein the third message generated by the first device includes a message authentication code determined using the third message, the second message, and the first message.

26. A communication system according to claim 25 wherein responsive to receipt of the third message, the second device determines an expected message authentication code using said third message, said second message, and said first message; and compares the expected message authentication code to the received message authentication code.

27. A communication system according to claim 26 wherein the second device discards the third message if the expected message authentication code does not match the received message authentication code.

28. A communication system according to claim 17 wherein the first and second device are elements of a mobile communication system.

29. A communication system according to claim 28, wherein the first and second devices are one of a mobile terminal and a network element.

30. A communication system according to claim 28, wherein the mobile communication system comprises a GERAN system.
